(19) United States
(12) Patent Application Publication
(10) Pub. No.: US 2023/0047382 A1
(43) Pub. Date: Feb. 16, 2023

(54) A PROTECTIVE LAYER FOR A METAL ELECTRODE AND LITHIUM BATTERY COMPRISING THE SAME

(71) Applicant: Evonik Operations GmbH, Essen (DE)

(72) Inventors: Ryo Takata, Hanau (DE); Franz Schmidt, Gross-Gerau (DE); Daniel Esken, Erlensee (DE); Ting-Tai Lee, Taipei City (TW); Chia-Chen Fang, Taipei City (TW); Nae-Lih Wu, Taipei (TW)

(73) Assignee: Evonik Operations GmbH, Essen (DE)

(21) Appl. No.: 17/758,652

(22) PCT Filed: Jan. 13, 2021
(86) PCT No.: PCT/EP2021/050567

§ 371 Date: Jul. 12, 2022

(30) Foreign Application Priority Data
Jan. 14, 2020 (EP) 20151611.9

(51) Int. Cl. H01M 4/58; H01M 4/36; H01M 10/052; H01M 4/525; H01M 4/62; H01M 4/38

(52) U.S. Cl. CPC H01M 4/58; H01M 4/366; H01M 10/052; H01M 4/525; H01M 4/623; H01M 4/382; H01M 2004/021

(57) ABSTRACT

An electrode for a lithium battery contains a metal layer coated with a coating layer containing an organic binder and a metal compound. The metal compound is selected from aluminium oxide, silicon dioxide, zirconium oxide, mixed oxides including zirconium, mixed oxides including aluminium, lithium zirconium phosphate, and mixtures thereof. The metal compound is made of aggregates of primary particles with a number mean primary particle size d₅₀ of 5 nm-100 nm, obtained by a pyrogenic process. The weight ratio of the metal compound to the organic binder in the coating layer is from 0.1 to 10.

### FIELD OF THE INVENTION

The invention relates to an electrode for a lithium battery, containing a metal layer coated with a coating layer comprising a binder and a fumed metal compound, a method for synthesis of such electrode and the use thereof in lithium batteries.

### BACKGROUND OF THE INVENTION

Various energy storage technologies have recently attracted much attention of public and have been a subject of intensive research and development at the industry and in the academia. As energy storage technologies are extended to devices such as cellular phones, camcorders and notebook PCs, and further to electric vehicles, demand for high energy density batteries used as a source of power supply of such devices is increasing. Secondary lithium-ion batteries are one of the most important battery types currently used.

### DESCRIPTION OF THE PRIOR ART

The secondary lithium ion batteries are usually composed of an anode made of a carbon or a silicon material or a lithium-metal alloy, a cathode made of a lithium-metal oxide, and an electrolyte in which a lithium salt is dissolved in an organic solvent. The separator of the lithium ion battery provides the passage of lithium ions between the positive and the negative electrode during the charging and the discharging processes.

Lithium metal batteries (LMB), such as lithium-sulfur (Li—S), lithium-air (Li-air), and solid-state lithium batteries have been reported to overcome at least some of the limitations, which lithium ion batteries still possess, such as lacking high energy storage capacity. However, the intrinsic properties of metallic Li generate several issues regarding safety and device instability leading to limited cycle-life. The highly reactive nature of Li triggers different processes with, generally, detrimental effect on the cycle-life of the battery such as liquid electrolyte degradation, Solid-Electrolyte-Interface (SEI) formation, corrosion of the Li anode due to the presence of minor traces of water in the electrolyte, Li dendrite formation, Li passivation through polysulfide shuttle effect in Li—S batteries. Consequently, the successful stabilization/protection of Li anode is mandatory for a realistic development of LMB technology.

Recently, several approaches have been pursued to stabilize the lithium metal-electrolyte interface, including soft polymeric coatings that have shown the ability to enable high-rate and high-capacity lithium metal cycling.

Thus, the controlled protection of Li anode with organic and/or inorganic materials has been disclosed to have a beneficial effect on the performance of the battery. CN109473627A describes preparation of a composite electrode comprising lithium metal, inorganic nanomaterial, such as titanium oxide, alumina, silica, boehmite, zirconia, having a particle size of 50-500 nm, an organic polymer and a membrane material by the following steps: (1) preparing a solution of a polymer and inorganic particles; (2) coating this solution of the surface of the membrane and subsequent drying; (3) grinding the dried composite material prepared in step (2) with metal lithium to form composite electrode particles covered with a composite layer and (4) shaping the composite electrode material to form metal lithium electrode sheet comprising lithium particles covered with a protective layer.

US 20170062829 A1 discloses a lithium metal battery comprising a lithium metal anode with a protective layer comprising a polymer, e.g. a styrene-isoprene co-polymer, at least one metal salt, and a nitrogen-containing additive, such as Li₃N. This protective layer can also contain not further specified in detail inorganic particles such as TiO₂, ZnO, Al₂O₃, SiO₂ with particle size of about 1-500 nm.

US 20140220439 A1 discloses an alkaline metal anode coated with a protective coating comprising inorganic particles, such as those containing the elements Al, Mg, Fe, Sn, Si, B, Cd, Sb, dispersed throughout a matrix of an organic compound, such as pyrrolidine derivatives.

US 20170301920 A1 discloses lithium metal electrode coated with a protective layer comprising a polymer ionic liquid, optionally inorganic nanoparticles, such as SiO₂, Al₂O₃, TiO₂, MgO, ZrO₂, ZnO, Fe₃O₄, barium titanate, lead titanate, lithium nitride, lithium aluminate.

Jang et al. describe in Adv. Funct. Mater. 2019, vol. 29 (48), No. 1905078, preparation of coated lithium metal anodes. Thus, a ZrO₂ powder with particle size 5 μm or a Al₂O₃ powder with an average particle size of 500 nm is mixed with a poly-(vinylidene fluoride-co-hexafluoropropylene) (PDdF-HFP) polymer, DMF, and an electrolyte followed by coating this slurry on the lithium metal foil of 450 μm thickness and drying to form a coating layer of 21.7 μm thickness.

WO 2019149939 A1 discloses lithium metal anode coated with a protective layer having a thickness of 0.01 to 10 μm, consisting a polymer and up to 30 wt %, relative to polymer, of inorganic particles such as Al₂O₃, MnO, MnO₂, SiO₂, TiO₂, ZnO, ZrO₂, Fe₂O₃, CuO, silicate, alumosilicate, borosilicate, having an average particle diameter of 1-500 nm.

Lee, Y., Fujiki, S., Jung, C. et al. describe in Nature Energy volume 5, pages 299-308 (2020) a high-performance all-solid-state lithium metal battery with a sulfide electrolyte and an Ag—C composite anode with no excess lithium. The metal layer of the composite Ag—C anode of this system can effectively regulate Li deposition, which leads to a prolonged electrochemical cyclability. Thus, in this case not a classical lithium anode is used, but a silver-based anode, whereon a lithium layer is reversibly deposited during the operation of the lithium battery.

### Problem and Solution

It is generally known, to protect the lithium electrodes of lithium batteries with polymers and various inorganic particles, such as metal oxides, for improving the cycling behaviour of the battery. However, the specific examples of such coatings usually contain relatively large inorganic particles and relatively low content of such inorganic particles in the coating. Although some documents generally refer to nanostructured inorganic particles with a particle size of less than 100-500 nm, no further details, such as to the preparation method or source of such particles are often provided. Mostly, no information is also provided to whether the inorganic particles are aggregated or agglomerated.

Importantly, the physicochemical properties of such protecting inorganic particles, such as the kind of particles, their particle size, particle size distribution, aggregation and agglomeration, as well as the content of such particles used for protection of the electrode, are of paramount importance for providing chemical stability of the metal lithium electrode during the cycling of lithium batteries.

Thus, the practical ways to improve the batteries long life are often limited. Thus, in the case of metal oxides, the use of commercially available nano-sized particles often leads to inhomogeneous distribution and large agglomerated particles on the surface of lithium electrode and as a result, minimal or no improvements in cycling performance are observed when compared with non-coated electrodes.

The problem addressed by the present invention is that of providing modified metal electrode for lithium batteries, especially for lithium metal batteries. Such modified electrode should provide a higher cycling stability than that of the unmodified materials.

In the course of thorough experimentation, it was surprisingly found that the combination of organic binders with selected pyrogenically produced metal compounds may be particularly suitable for coating of metal electrodes, e.g. lithium electrodes for the lithium-ion batteries.

The invention provides electrode for a lithium battery, containing a metal layer coated with a coating layer comprising an organic binder and a metal compound selected from the group consisting of aluminium oxide, silicon dioxide, zirconium oxide, mixed oxides comprising zirconium, mixed oxides comprising aluminium, lithium zirconium phosphate, and mixtures thereof, wherein the metal compound consists of aggregates of primary particles with a number mean primary particle size d₅₀ of 5 nm-100 nm, obtained by a pyrogenic process, and the weight ratio of the metal compound to the organic binder in the coating layer is from 0.1 to 10.

The metal compound of the present invention is obtained by a pyrogenic (also known as “fume” or “fumed”) process. Pyrogenic (fume) processes involve e.g. flame oxidation, flame hydrolysis or flame pyrolysis. Such processes involve oxidizing or hydrolysing of hydrolysable or oxidizable starting materials, generally in a hydrogen/oxygen flame. Starting materials used for pyrogenic methods include organic and/or inorganic metal compounds, such as metal chlorides, metal nitrates, metal carboxylates. In flame hydrolysis process, for example, metal precursors such as metal chlorides, are usually vaporized and reacted in a flame generated by the reaction of hydrogen and oxygen to form metal compound particles. The thus obtained powders are referred to as “pyrogenic” or “fumed” metal compounds. The reaction initially forms highly disperse primary particles, which in the further course of reaction coalesce to form aggregates, i.e. strongly bound primary particles and agglomerates, i.e. relatively weakly bound aggregates. The aggregate dimensions of these powders are generally in the range of 0.2 μm-2 μm. Said powders may be partially destructed and converted into the nanometre (nm) range particles, advantageous for the present invention, by suitable grinding. Pyrogenically prepared metal compounds are characterized by extremely small particle size, high specific surface area (BET), very high purity, spherical shape of primary particles, and the absence of pores. Preparation of fumed alumina by flame hydrolysis process is described in detail e.g. in DE 19943 291 A1.

The metal compound used in the present invention preferably has a specific surface area (BET) of 0.1 m²/g to 400 m²/g. The thermally untreated metal compound, i.e. the product of the pyrogenic process, wherein no further thermal treatment has been employed, preferably has a BET surface area of 5 m²/g-300 m²/g, more preferably of 7 m²/g-200 m²/g, most preferably of 15-150 m²/g. The thermally treated metal compound, i.e. the product of the pyrogenic process, wherein a further thermal treatment, e.g. a calcination step has been employed, preferably has a BET surface area of less than 10 m²/g, more preferably 0.1 m²/g-10 m²/g, more preferably of 0.2 m²/g-5 m²/g, most preferably of 0.3-3 m²/g. The specific surface area, also referred to simply as BET surface area, can be determined according to DIN 9277:2014 by nitrogen adsorption in accordance with the Brunauer-Emmett-Teller method.

The mixed oxide comprising zirconium present in the electrode of the present invention can further comprise other than zirconium metals M, such as one or several elements selected from the group consisting of Li, Na, K, Be, Mg, Ca, Sr, Ba, Zn, Co, Ni, Cu, Mn, B, Al, Ga, In, Fe, Sc, Y, La, Ti, Zr, Hf, Ce, Si, Ge, Sn, Pb, V, Nb, Ta, Mo, W. Silicon (Si) and boron (B) are regarded to be metals in the context of the present invention.

Preferably, M=Li, La and/or Al.

The mixed oxide comprising zirconium is preferably a compound of a general formula

LiₐZr_{b}M_{c}O_{0.5a+2b+d} (I),

wherein

1.5≤a≤15,

0.5≤b≤3.0,

0≤c≤5,

d=0.5c for M=Na, K;

d=c for M=Be, Mg, Ca, Sr, Ba, Zn, Co, Ni, Cu, Mn;

d=1.5c for M=B, Al, Ga, In, Fe, Sc, Y, La;

d=2c for M=Ti, Zr, Hf, Ce, Si, Ge, Sn, Pb;

d=2.5c for M=V, Nb, Ta;

d=3c for M=Mo, W.

The mixed oxide comprising aluminium can be lithium aluminate (LiAlO₂) or any other mixed oxide comprising lithium, aluminium and oxygen.

Lithium zirconium phosphate produced is preferably a compound of a general formula LiₐZr_{b}M_{c}(PO₄)_{d}, wherein M is at least one metal different from Li and Zr, 0.5≤a≤5.0, 0.5≤b≤5.0, 0≤c≤5, 1≤d≤5.

The metal compound used in the electrode according to the invention, is in the form of aggregated primary particles with a number mean primary particle size of 5-100 nm, preferably 7-70 nm, more preferably 10-50 nm, as determined by transition electron microscopy (TEM). This numerical mean diameter can be determined by calculating the average size of at least 500 particles analysed by TEM.

The particles of the metal compound used in the present invention, which is obtained by a pyrogenic process, are usually mostly in the form of aggregates, although some particles can be in the form of non-aggregated primary particles. The metal compound preferably has a number mean aggregate particle size d₅₀ of less than 2 μm, more preferably 20 nm-1 μm, more preferably 30 nm-800 nm, more preferably 40 nm-600 nm, 50 nm-500 nm. The number mean particle size d₅₀ can be determined in a suitable dispersion, e.g. in an aqueous dispersion, by static light scattering (SLS) method.

The agglomerates and partly the aggregates can be destroyed e.g. by grinding or ultrasonic treatment of the particles to result in particles with a smaller particle size and a narrower particle size distribution.

Preferably, the number mean aggregate particle diameter d₅₀ of the metal compound is 5 nm-250 nm, more preferably 10 nm-200 nm, even more preferably 15 nm-150 nm, as determined by static light scattering (SLS) after 300 s of ultrasonic treatment at 25° C. of a mixture consisting of 5% by weight of the particles and 95% by weight of a 0.5 g/L solution of sodium pyrophosphate in water.

The span (d₉₀−d₁₀)/d₅₀ of particles of the metal compound is preferably 0.4-1.2, more preferably 0.5-1.1, even more preferably 0.6-1.0, as determined by static light scattering (SLS) after 300 s of ultrasonic treatment at 25° C. of a mixture consisting of 5% by weight of the particles and 95% by weight of a 0.5 g/L solution of sodium pyrophosphate in water.

Thus, the metal compound present in the electrode of the present invention is preferably characterized by a relatively small number mean aggregate particle size d₅₀ and narrow particle size distribution (d₉₀-d₁₀)/d₅₀. This helps to achieve high-quality metal compound coating of the lithium electrode.

The d values d₁₀, d₅₀ and d₉₀ are commonly used for characterizing the cumulative particle diameter distribution of a given sample. For example, the d₁₀ diameter is the diameter at which 10% of a sample's volume is comprised of smaller than d₁₀ particles, the d₅₀ is the diameter at which 50% of a sample's volume is comprised of smaller than d₅₀ particles. The d₅₀ is also known as the “volume median diameter” as it divides the sample equally by volume; the d₉₀ is the diameter at which 90% of a sample's volume is comprised of smaller than d₉₀ particles.

The tamped density of the metal compound present in the electrode of the invention can be from 20 g/L to 1000 g/L. The thermally untreated metal compound preferably has a tamped density of 20 g/L-200 g/L, more preferably 30 g/L-150 g/L, even more preferably 40 g/L-130 g/L, still more preferably 50 g/L-120 g/L. The thermally treated, e.g. calcined metal compound preferably has a tamped density of 400 g/L-1000 g/L, more preferably 450 g/L-800 g/L, even more preferably 500 g/L-700 g/L. Tamped density of a pulverulent or coarse-grain granular material can be determined according to DIN ISO 787-11:1995 “General methods of test for pigments and extenders—Part 11: Determination of tamped volume and apparent density after tamping”. This involves measuring the apparent density of a bed after agitation and tamping.

The metal compound used in the electrode of the present invention is preferably hydrophilic in nature, that is not further treated by any hydrophobic reagents, such as silanes, after its synthesis by a pyrogenic process. The particles thus produced usually have a purity of at least 96% by weight, preferably at least 98% by weight, more preferably at least 99% by weight, wherein the 100% purity means that the metal compound contains only the required elements in the proportions corresponding to the chemical formula of the used metal compound. The content of chloride is preferably less than 0.5% by weight, more preferably less than 0.1% by weight, based on the mass of the metal compound powder. The proportion of carbon is preferably less than 2.0% by weight, more preferably 0.005%-1.0% by weight, even more preferably 0.01%-0.5% by weight, based on the mass of the metal compound powder.

The Surface Treated Metal Compound

The metal compound present in the electrode according to the invention can be surface treated. This surface treatment, particularly a hydrophobic surface treatment may improve the compatibility of metal compound particles with the organic binder.

The metal compound present in the electrode of the invention can be hydrophobic and have a methanol wettability of a methanol content of greater than 5%, preferably of 10% to 80%, more preferably of 15% to 70%, especially preferably of 20% to 65%, most preferably of 25% to 60%, by volume in a methanol/water mixture.

The terms “hydrophobic” or “hydrophobized” in the context of the present invention relate to the particles having a low affinity for polar media such as water. The hydrophilic particles, by contrast, have a high affinity for polar media such as water. The hydrophobicity of the hydrophobic materials can typically be achieved by the application of the appropriate nonpolar groups to the surface of particles. The extent of the hydrophobicity of the metal compound can be determined via parameters including its methanol wettability, as described in detail, for example, in WO2011/076518 A1, pages 5-6. In pure water, hydrophobic particles of a metal compound separate completely from the water and float on the surface thereof without being wetted with the solvent. In pure methanol, by contrast, hydrophobic particles are distributed throughout the solvent volume; the complete wetting takes place. In the measurement of methanol wettability, a maximum methanol content at which there is still no wetting of the metal compound, is determined in a methanol/water test mixture, meaning that 100% of the metal compound used remains separate from the test mixture after contact with the test mixture, in unwetted form. This methanol content in the methanol/water mixture in % by volume is called methanol wettability. The higher the level of such methanol wettability, the more hydrophobic the metal compound. The lower the methanol wettability, the lower the hydrophobicity and the higher the hydrophilicity of the material.

The metal compound of the present invention can be surface treated, e.g. hydrophobized, with a surface treatment agent selected from the group consisting of organosilanes, silazanes, acyclic polysiloxanes, cyclic polysiloxanes, and mixtures thereof.

The hydrophobic metal compound preferably has a carbon content of 0.1% to 15.0%, more preferably of 0.5% to 10.0% by weight, more preferably of 1.0% to 5.0% by weight. The carbon content may be determined by elemental analysis according to EN ISO3262-20:2000 (Chapter 8). The analysed sample is weighed into a ceramic crucible, provided with combustion additives and heated in an induction furnace under an oxygen flow. The carbon present is oxidized to CO₂. The amount of CO₂ gas is quantified by infrared detectors.

The Metal Layer

The term “layer” in the context of the present invention means a continuous deposition of the corresponding substance or component on the surface of another substance or component.

The metal layer of the inventive electrode, e.g. a lithium layer can additionally be supported on a metal foil, which serves as a current collector. This metal foil can comprise lithium, aluminium, copper, silver, gold, nickel, iron, steel, stainless steel, titanium, or metal alloys thereof. Such metal alloys can also comprise non-metallic components, such as e.g. silicon, germanium. Most preferably, especially if the inventive electrode is used in combination with a liquid electrolyte, the metal foil consists of copper. A stainless-steel foil is preferably used in electrodes used in combination with solid electrolytes, e.g. sulfidic electrolytes. Such metal foil can have a thickness of 0.5 μm-500 μm, more preferably 1 μm-100 μm, more preferably 5 μm-30 μm. This metal foil can further be supported on a polymer substrate.

The electrode according to the invention preferably comprises a layer of the metal with a thickness of 2 μm-500 μm, more preferably 3 μm-300 μm, more preferably 5 μm-200 μm.

The metal layer can be coated on the metal foil by any suitable method, such as vacuum deposition methods.

The Coating Layer

The coating layer present in the electrode of the invention comprises an organic binder and a metal compound selected from the group consisting of aluminium oxide, zirconium oxide, mixed oxides comprising zirconium, mixed oxides comprising aluminium, lithium zirconium phosphate, and mixtures thereof.

The weight ratio of the metal compound to the organic binder in the coating layer is from 0.1 to 10, preferably from 0.2 to 9.5, more preferably from 0.3 to 9.0, more preferably from 0.4 to 8.5, more preferably from 0.5 to 8.0, more preferably from 0.8 to 7.0, more preferably from 1.0 to 6.0.

The electrode of the invention can comprise a lithium salt, which can optionally be added to the coating layer. The lithium salt can be selected from the group consisting of lithium hexafluorophosphate (LiPF₆), lithium bis 2-(trifluoromethylsulfonyl)imide (LiTFSI), lithium bis (fluorosulfonyl) imide (LiFSI), lithium perchlorate (LiClO₄), lithium tetrafluoroborate (LiBF₄), Li₂SiFs, lithium triflate, Lithium bis(perfluoroethylsulfonyl)imide (LiN(SO₂CF₂CF₃)₂), lithium nitrate, lithium bis(oxalate)borate, lithium-cyclo-difluoromethane-1,1-bis(sulfonyl)imide, lithium-cyclo-hexafluoropropane-1,1-bis(sulfonyl)imide and mixtures thereof. Lithium bis (fluorosulfonyl) imide (LiFSI) is preferably used as lithium salt in the coating layer in combination with a solid electrolyte.

The thickness of the coating layer can be 0.1 μm-300 μm, more preferably 0.5 μm-100 μm, more preferably 1 μm-50 μm, more preferably 5 μm-20 μm.

The Organic Binder

The coating layer of the inventive electrode comprises an organic binder. The material of the organic binder is not particularly limited as long as this material allows efficient adhesion between the metal compound particles and the surface of the lithium layer. The binder can be selected from the group consisting of poly(vinylidene fluoride), copolymer of vinylidene fluoride and hexafluoropropylene, poly(vinyl acetate), poly(ethylene oxide), poly(methyl methacrylate), poly(ethyl acrylate), poly(vinyl chloride), poly(urethane), poly(acrylonitrile), poly(ethylene glycol) and poly(ethylene glycol)-dimethyl ether, poly(ether amine), copolymer of ethylene and vinyl acetate, carboxyl methyl cellulose, poly(imide), and mixtures thereof.

The Process for Producing the Electrode

The invention further provides a process for producing the inventive electrode, comprising the following steps:

(1) preparing a mixture comprising an organic binder, a metal compound selected from the group consisting of aluminium oxide, silicon dioxide, zirconium oxide, mixed oxides comprising zirconium, mixed oxides comprising aluminium, lithium zirconium phosphate, and the mixtures thereof, and optionally a lithium salt selected from the group consisting of lithium hexafluorophosphate (LiPF₆), lithium bis 2-(trifluoromethylsulfonyl)imide (LiTFSI), lithium bis (fluorosulfonyl) imide (LiFSI), lithium perchlorate (LiClO₄), lithium tetrafluoroborate (LiBF₄), Li₂SiFs, lithium triflate, Lithium bis(perfluoroethylsulfonyl)imide (LiN(SO₂CF₂CF₃)₂), lithium nitrate, lithium bis(oxalate)borate, lithium-cyclo-difluoromethane-1,1-bis(sulfonyl)imide, lithium-cyclo-hexafluoropropane-1,1-bis(sulfonyl)imide and mixtures thereof, wherein the metal compound consists of aggregates of primary particles with a number mean primary particle size d₅₀ of 5 nm-100 nm and is obtained by a pyrogenic process, and optionally a solvent, wherein the weight ratio of the metal compound to the organic binder is from 0.1 to 10, preferably from 0.2 to 9.5, more preferably from 0.3 to 9.0, more preferably from 0.4 to 8.5, more preferably from 0.5 to 8.0, more preferably from 0.8 to 7.5, more preferably from 1.0 to 6.0.

(2) coating the mixture prepared in step (1) on the surface of a metal layer;

(3) optional drying and/or curing the coating layer prepared in step (2).

The solvent optionally used in step (1) of the inventive process is not particularly limited, as long as it may dissolve the binder and does not react with lithium metal during the coating process. A non-exhaustive list of suitable solvents comprises 1,2-dimethoxyethane, diethyl ether, tetrahydrofuran, dioxane, bis (2-methoxyethyl) ether, pentane, hexane, heptane, octane, decane, toluene, ethanol, isopropanol, N-Methyl-2-pyrrolidone, triethyl phosphate, dimethyl sulfoxide, methyl ethyl ketone, methyl isobutyl ketone, benzaldehyde, N,N-dimethylformamide, dimethylacetamide, acetonitrile, cyclohexanone, ethyl acetate, propylene carbonate, ethylene carbonate, diethylene glycol monomethyl ether, triethylene glycol methyl ether, acetylacetone, acetone and the mixtures thereof.

The mixture prepared in step (1) of the process according to the invention can be obtained from two or more mixtures, for example, the first mixture comprising the metal compound particles and a solvent, the second mixture comprising the organic binder, a solvent and optionally a lithium salt.

Preferably, such a first mixture comprises 1%-70%, preferably 10%-60%, more preferably 20%-50%, more preferably 30%-45%, by weight of the metal compound and 30%-99%, preferably 40%-90%, more preferably 50%-80%, more preferably 55%-70%, by weight of the solvent.

The second mixture can comprise 0.1%-90%, preferably 0.5%-50%, more preferably 1%-20%, more preferably 2%-10%, by weight of the organic binder and 10%-99.9%, preferably 50%-99.5%, more preferably 80%-99%, more preferably 90%-98%, by weight of the solvent.

In step (2) of the inventive process, the metal layer is coated with the mixture prepared in step (1) to form a coating layer comprising the metal compound and the organic binder on the surface of the metal layer. Any suitable coating method allowing application of a relatively thin coating layer may be applied. An example of a suitable apparat for coating step is doctor blade device SA-202 (manufacturer: Tester Sangyo).

The mixture coated on the metal layer in step (2), is further optionally dried and/or cured on the surface of the metal layer in step (3) of the inventive process leading to formation of the inventive coated metal electrode.

Curing of the coating mixture can occur, for example by polymerization, crosslinking reaction or another type of chemical reaction or by physical curing by evaporation of the solvents or other volatile components of the binder. Chemical curing can take place, for example, thermally or under the action of UV radiation or other radiation.

Depending on the system used, step (3) can preferably take place at a temperature of from 0° C. to 500° C., more preferably from 5° C. to 400° C., more preferably from 10° C. to 300° C., more preferably from 20° C. to 150° C. The drying/curing step can take place in the presence of air or preferably with exclusion of oxygen, for example under a protective-gas atmosphere of nitrogen or argon. Said step can take place under standard pressure or under a reduced pressure, for example under vacuum.

Use of the Electrode

The invention further provides the use of the inventive electrode as a constituent of a lithium metal or lithium ion battery, preferably of a lithium metal battery.

The Battery

The invention further provides battery comprising the electrode according to the invention. The inventive electrode usually serves as an anode in such a battery.

The battery can be a lithium ion battery and further comprise a separator or a solid electrolyte, a cathode, an anode and/or an electrolyte comprising a lithium salt.

The cathode of the lithium ion battery usually includes a current collector and an active cathode material layer formed on the current collector.

The current collector may be a lithium foil, a copper foil, a nickel foil, an aluminium foil, an iron foil, a steel foil, a stainless-steel foil, a titanium foil, a metal alloy foil, a polymer substrate coated with a conductive metal, or a combination thereof.

The active cathode materials include materials capable of reversible intercalating/deintercalating lithium ions and are well known in the art. Such active cathode material may include lithium metal, a lithium alloy, sulfur, lithium sulfide, silicon, silicon oxide, silicon carbide composite, silicon alloy, Sn, SnO₂, or a transition metal compound, such as mixed oxides including Li, Ni, Co, Mn, Fe, P, Al, V or other transition metals.

The liquid electrolyte of the lithium-ion battery may comprise any suitable organic solvent commonly used in the lithium-ion batteries, such as anhydrous ethylene carbonate (EC), dimethyl carbonate (DMC), propylene carbonate, methylethyl carbonate, diethyl carbonate, gamma butyrolactone, dimethoxyethane, fluoroethylene carbonate, vinylethylene carbonate, or a mixture thereof.

The electrolyte of the lithium ion battery usually contains a lithium salt. Examples of such lithium salts include lithium hexafluorophosphate (LiPF₆), lithium bis 2-(trifluoromethylsulfonyl)imide (LiTFSI), lithium bis (fluorosulfonyl) imide (LiFSI), lithium perchlorate (LiClO₄), lithium tetrafluoroborate (LiBF₄), Li₂SiF₆, lithium triflate, LiN(SO₂CF₂CF₃)₂ and mixtures thereof.

The lithium ion battery may comprise a liquid electrolyte, a gel electrolyte or a solid electrolyte. The liquid mixture of the lithium salt and the organic solvent, which is not cured, polymerized or cross-linked, is referred to as “liquid electrolyte” in the context of the present invention. The gel or solid mixture comprising a cured, polymerized or cross-linked compound or their mixtures, optionally a solvent, and the lithium salt is referred to as a “gel electrolyte”. Such gel electrolytes can be prepared by polymerization or crosslinking of a mixture, containing at least one reactive, i.e. polymerizable or cross-linkable, compound and a lithium salt.

A special type of lithium ion battery is a lithium-polymer battery, wherein a polymer electrolyte is used instead of a liquid electrolyte. The electrolyte of a similar solid-state battery can also comprise other types of solid electrolytes, such as sulfidic, oxidic solid electrolytes, or mixtures thereof.

The battery of the invention can be a lithium metal battery, such as Li-air, lithium sulfur (Li—S), and other types of lithium metal batteries.

A Li-air battery typically contains a porous carbon cathode and an organic, glass-ceramic or polymer-ceramic type electrolyte.

A Li-sulphur (Li—S) battery usually contains an iron disulphide (FeS₂), an iron sulfide (FeS), a copper sulfide (CuS), a lead sulfide and a copper sulfide (PbS+CuS) cathode.

There are also many other known types of lithium metal batteries such as e.g. lithium-selenium (Li—Se), lithium-manganese dioxide (Li—MnO₂ or Li/Al—MnO₂), lithium-monofluoride (Li—(CF)ₓ), lithium-thionyl chloride (Li—SOCl₂), lithium-sulfuryl chloride (Li—SO₂Cl₂), lithium-sulfur dioxide (Li—SO₂), lithium-iodine (Li—I₂), lithium-silver chromate (Li—Ag₂CrO₄), lithium-vanadium pentoxide (Li—V₂O₅ or Li/AI-V₂O₅), lithium-copper chloride (Li—CuCl₂), lithium copper (II) oxide (Li—CuO), lithium-copper oxyphosphate (Li—Cu₄O(PO₄)₂) and other types.

### BRIEF DESCRIPTION OF THE DRAWINGS

FIG. 1a shows polarized voltages with different metal compounds at the current density of 0.1 mA/cm² in liquid electrolytes.

FIG. 1b shows polarized voltages with different metal compounds at the current density of 0.5 mA/cm² in liquid electrolytes.

FIG. 1c shows polarized voltages with materials from examples 12a-14a at the current densities of 0.05 (cycle 1-5) to 0.1 (cycle 5-9) mA/cm² in hybrid solid electrolytes.

FIG. 1d shows polarized voltages with materials from examples 12a-14a at the current densities of 0.25 (cycle 1-5) to 0.5 (cycle 5-9) mA/cm² in hybrid solid electrolytes.

FIG. 2 (A) shows plating and stripping cycles for the example 6a.

FIG. 2 (B) shows plating and stripping cycles for the example 5a.

FIG. 2 (C) shows plating and stripping cycles for the example 4a.

FIG. 3 shows cycle performance of the Li—Cu asymmetric cells.

FIG. 4 (A) shows a SEM image for the electrode from example 8b indicating the volume expansion ratio of the electrode in comparison to the reference without alumina-polymer coating (reference value 100%).

FIG. 4 (B) shows a SEM image for the electrode from example 7b indicating the volume expansion ratio of the electrode in comparison to the reference without alumina-polymer coating (reference value 100%).

FIG. 4 (C) shows a SEM image for the electrode from example 4b indicating the volume expansion ratio of the electrode in comparison to the reference without alumina-polymer coating (reference value 100%).

### EXAMPLES

### Metal Compound Samples

AEROXIDE Alu 130 is a fumed alumina with BET=130 m²/g supplied by Evonik Operations GmbH.

TAMICON® TM-DAR (referred to as “TM-DAR” below) is an (alpha) alumina oxide with BET=14.5 m²/g supplied by Taimei Chemicals Co., Ltd.

(Alpha) aluminum oxide powder with BET=3.9 m²/g supplied by US Research Nanomaterials, Inc. is referred to as “USR” below.

Evonik ZrO₂ is a fumed zirconium oxide with BET=40 m²/g supplied by Evonik Operation GmbH.

LLZO precursor particle is a fumed aluminum doped lithium lanthanum zirconium oxide particle with a BET of about 28 m²/g supplied by Evonik Operations GmbH.

Cubic LLZO particle is a fumed and calcined aluminum doped lithium lanthanum zirconium oxide particle with a BET of about 0.4 m²/g supplied by Evonik Operations GmbH.

Evonik ball milled (BM) c-LLZO (referred to as “BM c-LLZO” below) is a fumed, calcined and ball milled aluminum doped lithium lanthanum zirconium oxide particle with a BET of about 10 m²/g supplied by Evonik Operations GmbH.

NEI LLZO (referred to as “NEI LLZO” below) is a cubic phase aluminum doped lithium lanthanum zirconium oxide with BET of about 4.8 m²/g supplied by NEI Corporation, Physical properties of tested metal compound particles are summarized in Table 1.

TABLE 1
Physical properties of the tested metal compound particles

| | BET, | Average primary | Crystal |
|---|---|---|---|
| Metal compounds | [m²/g] | particle size, [nm] | structure |
| AEROXIDE ® Alu 130 | 130 | 15-25 | Beta & gamma |
| (alumina) | | | |
| TM-DAR (alumina) | 14.5 | 80-100 | Alpha |
| USR (alumina) | 3.9 | 400-500 | Alpha |
| Evonik ZrO₂ | 40 | 20-50 | Tetragonal & |
| | | | monoclinic |
| Evonik LLZO precursor | 28 | 20-50 | Pyrochlore |
| particle | | | La₂Z₂O₇ + |
| | | | Li₂CO₃ |
| NEI LLZO | 4.8 | Approx. 1000 | Cubic phase |
| Evonik c-LLZO | 0.4 | Approx. 10000 | Cubic phase |
| Evonik BM c-LLZO | 10 | Approx. 100-1000 | Cubic phase |

Preparation of the Coated Electrode Sheets

### Example 1a

A copper foil with a thickness of 12 μm covered with a lithium metal layer with a thickness of 100 μm was provided. AEROXIDE® Alu 130 particles were dispersed in 1,2-dimethoxyethane (DME), to obtain a first solution with a solid content of 40 wt %. Poly(vinylidene fluoride-co-hexafluoropropylene) (PVDF-HFP) (supplier: Sigma-Aldrich, weight average molecular weight (Mw) about 400,000 g/mol) was also dissolved in DME, to obtain a second solution with a solid content of 5 wt %. Both the first and the second solution were stirred vigorously for several hours and then mixed together under stirring in such a ratio to produce a mixture with a 1:1 ratio (by weight) of alumina to PVDF-HFP polymer. This mixture was coated on the lithium metal layer by solvent casting method: the raw mixture slurry was stirred by a magnet stirrer in a 20 mL sample vial followed by coating by pen brush at one time. After heating at 70° C. for 30 min on a hot plate, an electrode sheet having artificial solid electrolyte interphase (ASEI) layer with a thickness of about 10 μm was obtained.

### Example 1b

The same as described in example 1a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 2a

The same as described in example 1a with the only difference that the mixture comprising a 1:1 (weight ratio) mixture of alumina particles TM-DAR and PVDF-HFP was used for coating of the electrode sheet.

### Example 2b

The same as described in example 2a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 3a

The same as described in example 1a with the only difference that the mixture comprising a 1:1 (weight ratio) mixture of alumina particles USR and PVDF-HFP was used for coating of the electrode sheet.

### Example 3b

The same as described in example 3a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 4a

The same as described in example 1a with the only difference that the mixture comprising a 4:1 (weight ratio) mixture of alumina particles AEROXIDE® Alu130 and PVDF-HFP was used for coating of the electrode sheet.

### Example 4b

The same as described in example 4a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 5a

The same as described in example 1a with the only difference that the mixture comprising a 4:1 (weight ratio) mixture of alumina particles TM-DAR and PVDF-HFP was used for coating of the electrode sheet.

### Example 5b

The same as described in example 5a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 6a

The same as described in example 1a with the only difference that the mixture comprising a 4:1 (weight ratio) mixture of alumina particles USR and PVDF-HFP was used for coating of the electrode sheet.

### Example 6b

The same as described in example 6a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 7a

The same as described in example 1a with the only difference that the mixture comprising a 6:1 (weight ratio) mixture of alumina particles TM-DAR and PVDF-HFP was used for coating of the electrode sheet.

### Example 7b

The same as described in example 7a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 8a

The same as described in example 1a with the only difference that the mixture comprising a 6:1 (weight ratio) mixture of alumina particles USR and PVDF-HFP was used for coating of the electrode sheet.

### Example 8b

The same as described in example 8a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 9a

The same as described in example 4a with the only difference that the mixture comprising a 4:1 (weight ratio) mixture of ZrO₂ particles and PVDF-HFP was used for coating of the electrode sheet.

### Example 10a

The same as described in example 4a with the only difference that the mixture comprising a 4:1 (weight ratio) mixture of Evonik LLZO precursor particle and PVDF-HFP was used for coating of the electrode sheet.

### Example 10b

The same as described in example 10a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 11a

The same as described in example 4a with the only difference that the mixture comprising a 6:1 (weight ratio) mixture of NEI LLZO and PVDF-HFP was used for coating of the electrode sheet.

### Example 11b

The same as described in example 11a with the differences that the copper foil without a lithium metal layer was used instead of lithium deposited copper foil as the electrode sheet and acetone as a solvent was used instead of 1,2-dimethoxyethane (DME) for the dispersion of oxide particles and to dissolve Poly(vinylidene fluoride-co-hexafluoropropylene) (PVDF-HFP) for the coating formulation.

### Example 12a

A copper foil (with a thickness of 10 μm) having a lithium metal layer (with a thickness of 100 μm) was provided. PVDF-HFP was dissolved in DME, obtaining the first solution (with a solid content of 5 wt %). AEROXIDE® Alu 130 (alumina particles) was dispersed into the first solution (the mixtures were stirred vigorously for several hours) with 50 wt % alumina particles and 50 wt % PVDF-HFP obtaining the final slurry (with a solid content of 9.5 wt %). The mixture was coated on the lithium metal layer with brush by solvent casting. After baking at 70° C. for 30 min on hot plate for removing DME, both the electrodes were then covered by hybrid solid electrolyte film (details are described in Li—Li symmetrical cell fabrication in a solid (hybrid) polymer electrolyte) for the coin cell assembling.

### Example 13a

The same as described in example 12a with the only difference that lithium bis (fluorosulfonyl) imide (LiFSI, supplied by Kishida Chemical Co., Ltd.) was dissolved into the second slurry with continued stirring for 1 minute. The mixture was dripped onto the lithium metal layer, then covered by hybrid solid electrolyte film. The other side of film was also dripped by the mixture, and then quickly covered with another lithium metal electrode.

### Example 14a

Both the lithium metal electrodes without protective layer were covered by hybrid solid electrolyte film (details are described in Li—Li symmetrical cell fabrication in a solid (hybrid) polymer electrolyte) for the coin cell assembling.

The used in examples 1a,b-14 a,b weight ratios of metal compound particles to PVDF-HFP are summarized in Table 2-1 and Table 2-2.

TABLE 2-1
Preparation of the electrode sheets coated with
metal compound particles in liquid electrolyte.

| | Oxide particle:PVDF-HFP ratio (by weight) | | | | | |
|---|---|---|---|---|---|---|
| Metal compounds | 1:1 | | 4:1 | | 6:1 | |
| Coated layer | Li | Cu | Li | Cu | Li | Cu |
| onto | | | | | | |
| AEROXIDE ® | Example | Example | Example | Example | Not available | |
| Alu 130 | 1a | 1b | 4a | 4b | | |
| TM-DAR | Example | Example | Example | Example | Example | Example |
| | 2a | 2b | 5a | 5b | 7a | 8b |
| USR | Example | Example | Example | Example | Example | Example |
| | 3a | 3b | 6a | 6b | 8a | 8b |
| Evonik ZrO₂ | | | Example | | | |
| | | | 9a | | | |
| Evonik LLZO | | | Example | Example | | |
| precursor | | | 10a | 10b | | |
| NEI LLZO | | | | | Example | Example |
| | | | | | 11a | 11b |

TABLE 2-2
Preparation of the electrode sheets coated with metal compound
particles in solid (hybrid) polymer electrolyte.

| | Metal compound:PVDF-HFP:LiFSI ratio | | |
|---|---|---|---|
| | (by weight) | | |
| | Without protective | | |
| Metal compound | layer | 1:1:0 | 1:1:16 |
| Solid (hybrid) | Evonik BM c-LLZO: (PEO + LiTFSI) ratio (by | | |
| polymer electrolyte | weight) = 3:7 | | |
| AEROXIDE ® | Example 14a | Example 12a | Example 13a |
| Alu 130 | | | |

Li—Li Symmetrical Cell Fabrication in Liquid Electrolyte

A 1 M lithium bis(trifluoromethanesulfonyl)imide (supplier: KISHIDA, >99.9%) solution in 1:1 vol./vol. 1,3-dioxolane (supplier: Sigma-Aldrich, 99.8%):1,2-dimethoxyethane (supplier: KISHIDA, 99.9%) containing 1 wt % lithium nitrate (supplier: Sigma-Aldrich, stored in a glovebox for a week) was used as an electrolyte composition. The first coated electrode sheet, a polypropylene-polyethylene-polypropylene (PP/PE/PP) separator (Celgard® 2320, supplier: Celgard) with a thickness of about 10-20 μm, and the second (identical to the first one) electrode sheet were placed in sequence (metal compound coating layer of each electrode sheet was faced toward the separator) and sealed within an CR2320 coin cell.

Li—Li Symmetrical Cell Fabrication in Solid (Hybrid) Polymer Electrolyte

Weighted Evonik ball milled c-LLZO was ground, milled with polyethylene oxide (PEO, purchased from Sigma-Aldrich) and lithium bis(trifluoromethanesulfonyl)imide (LiTFSI, purchased from Kishida Chemical Co., Ltd). Weighted LLZO to obtain a paste-like material, which was then annealed at 100° C. for overnight, successively hot-pressed at 100° C. between Teflon substrates for a desired thickness. The molar ratio of [O]:[Li] was set as 15:1. This hybrid solid electrolyte (HSE) was used as separator as well as the solid electrolyte. The first coated electrode sheet, HSE with a thickness of about 110 μm, and the second (identical to the first one) electrode sheet were placed in sequence (metal compound coating layer of each electrode sheet was faced toward the separator) and sealed within an CR2320 coin cell.

Electrochemical Tests (Cell Cycling Tests)

Electrochemical cycling tests were carried out using CR2032-type coin cells on Arbin BT2000 battery testers at room temperature. Voltage vs. time(cycles) profiles during galvanostatic cycling of Li—Li cells are related to electrode stability and failure. Voltage profiles of Li stripping and plating in a Li—Li symmetric cell were measured at a current density of 0.1 mAh/cm² and 0.5 mAh/cm².

The procedure for Li—Li symmetric cell tests curried out at room temperature was as follows:

Rest 10 sec.

a. Charge 0.1 mA/cm² for 5 h, record every 5 min, then rest 10 min;

b. Discharge 0.1 mA/cm² for 5 h, record every 5 min, then rest 10 min;

Repeat a. and b. for 5 cycles

c. Charge 0.5 mA/cm² for 1 h, record every 30 sec., then rest 10 min;

d. Discharge 0.5 mA/cm² for 1 h, record every 30 sec., then rest 10 min;

Repeat c. and d. for 5 cycles

e. Charge 1 mA/cm² for 0.5 h, record every 15 sec., then rest 10 min;

f. Discharge 1 mA/cm² for 0.5 h, record every 15 sec., then rest 10 min;

Repeat a. b. for 5 cycles

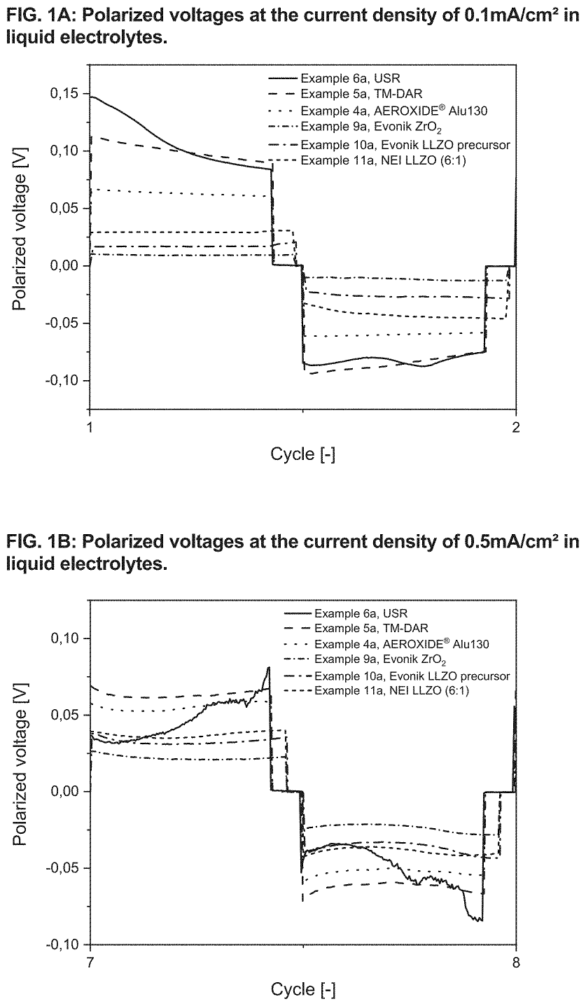

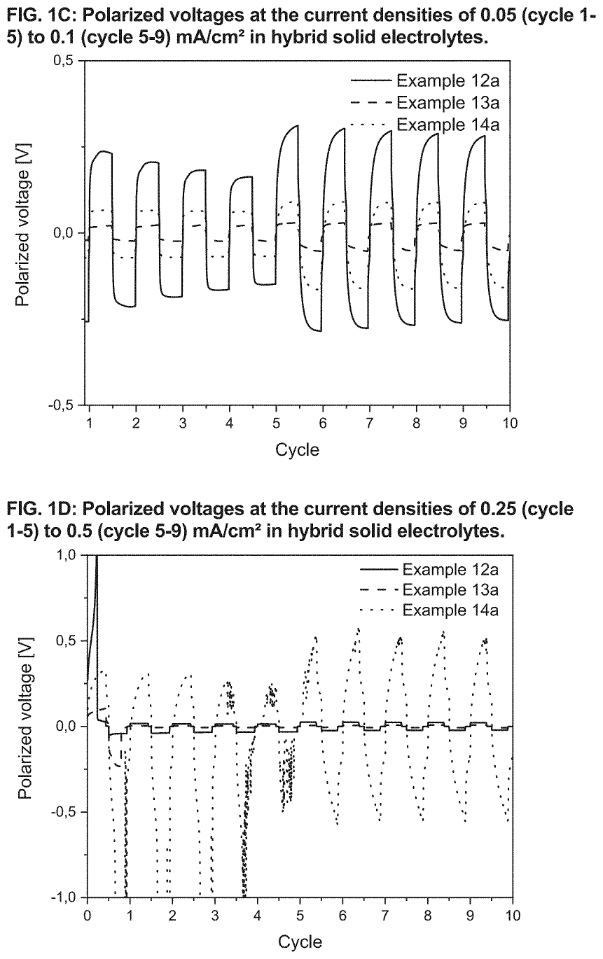

The determination of the voltage profiles with different alumina particles showed the lowest polarization voltage for systems comprising AEROXIDE® Alu130 alumina particles as FIG. 1a and FIG. 1a with the current density of 0.1 mA/cm² and 0.5 mA/cm². (Table 3: example 1a vs examples 2a and 3a; example 4a vs. examples 5a and 6a).

As to the alumina particles:polymer ratio, the voltage profile with the compounding ratio of AEROXIDE® Alu130 alumina particles to the PVDF-HFP=4:1 (FIG. 1, Table 3, example 4a) showed the lowest polarization voltage and the flattest profile among all the tested alumina samples and alumina particles:polymer ratios.

TABLE 3-1
The results of the polarized voltage measurements for the electrodes
coated with metal compound/PVDF-HFP in the liquid electrolyte.

| | Polarized voltage | Polarized voltage |
|---|---|---|
| | at 0.1 mA/cm² | at 0.5 mA/cm² |
| Example 1a | 15 mV | 30 mV |
| Example 2a | 25 mV | 50 mV |
| Example 3a | 30 mV | 55 mV |
| Example 4a | 15 mV | 25 mV |
| Example 5a | 25 mV | 45 mV |
| Example 6a | 30 mV | 45 mV |
| Example 7a | 25 mV | 35 mV |
| Example 8a | 30 mV | 40 mV |
| Example 9a | 10 mV | 20 mV |
| Example 10a | 15 mV | 30 mV |
| Example 11a | 30 mV | 40 mV |

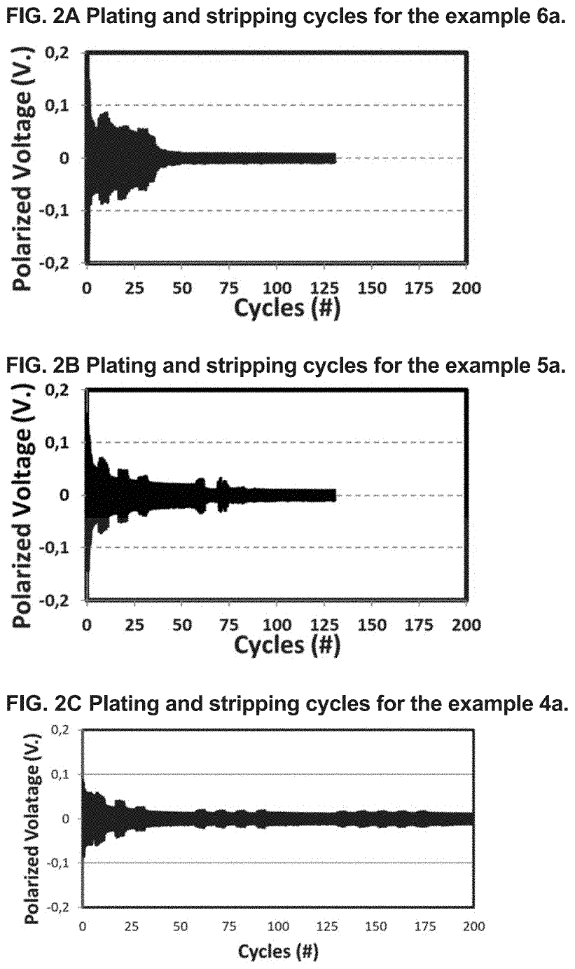

The coated electrode sheets of examples 4a, 5a, and 6a which compounding ratio of alumina particles and PVDF-HFP=4:1, were further cycled at the current density of 1 mA/cm² and plating and stripping capacity of 0.5 mAh/cm² to compare the cycling performance of the examples of Li—Li symmetric cells (example 4a: FIG. 2 (C); example 5a: FIG. 2 (B); example 6a: FIG. 2 (A)). It was not possible to continue the cycling with the electrodes of example 5a and 6a containing the alumina particles TM-DAR and USR. This indicates that the lithium dendrite formation was not prevented. On the other hand, the sample 4a was able to continue the cycling over 200 cycles and also showed the stable polarized voltage profile. That indicates that the lithium dendrite formation was mitigated.

TABLE 3-2
The results of the polarized voltage measurements
for the electrodes coated with metal compound/PVDF-
HFP in the hybrid solid electrolyte.

| | Polarized | Polarized | Polarized | Polarized |
|---|---|---|---|---|
| | voltage at | voltage at | voltage at | voltage at |
| | 0.05 | 0.1 | 0.25 | 0.5 |
| | mA/cm² | mA/cm² | mA/cm² | mA/cm² |
| Example 12a | 250 mV | 300 mV | not | not |
| without Li | | | measurable | measurable |
| salt | | | | |
| Example 13a | 15 mV | 30 mV | not | not |
| with LiFSI | | | measurable | measurable |
| Example 14a | 50 mV | 90 mV | 300 mV | 500 mV |
| without the | | | | |
| protective | | | | |
| layer | | | | |

Li—Cu Asymmetrical Cell Fabrication

In order to further analyze the coulombic efficiency using the protection layer, Li—Cu asymmetrical cells were fabricated.

1 M lithium bis(trifluoromethanesulfonyl)imide (KISHIDA, >99.9%) solution in 1:1 v/v 1,3-dioxolane (supplier: Sigma-Aldrich, 99.8%):1,2-dimethoxyethane (supplier: KISHIDA, 99.9%) containing 1 wt % lithium nitrate (supplier: Sigma-Aldrich, stored in a glovebox for a week) was used as an electrolyte composition. The first coated electrode sheet, a polypropylene-polyethylene-polypropylene (PP/PE/PP) separator (Celgard® 2320, supplier: Celgard) with a thickness of about 10-20 μm, and the second (identical to the first one) electrode sheet were placed in sequence (metal compound coating layer of each electrode sheet was faced toward the separator) and sealed within an CR2320 coin cell.

Cycling Tests

The cycling tests using Li—Cu asymmetric cells were performed for the examples of 1b, 2b, 3b, 4b, 7b, 8b, 10b and 11 b. Coulombic efficiency was measured.

The Procedure for Li—Cu Asymmetric Cell CE_{avg.} Tests was as Follows:

a. Discharge 0.5 mA/cm² for 10 h, record every 3 min;

b. Charge 0.5 mA/cm² for 10 h, record every 3 min;

Repeat a. and b. for 2 cycles

Discharge 0.5 mA/cm² for 10 h, record every 3 min;

Charge 0.5 mA/cm² for 2 h, record every 3 min;

a. Discharge 0.5 mA/cm² for 2 h, record every 3 min;

b. Charge 0.5 mA/cm² for 2 h, record every 3 min;

Repeat a. and b. for 11 cycles

Discharge 0.5 mA/cm² for 2 h, record every 3 min;

Charge 0.5 mA/cm² until >1V, record every 3 min.

The Procedure for Li—Cu Asymmetric Cell CE Cycling Tests was as Follows:

a. Discharge 0.5 mA/cm² for 2 h, record every 3 min;

b. Charge 0.5 mA/cm² until >1V, record every 3 min;

Repeat a. and b.

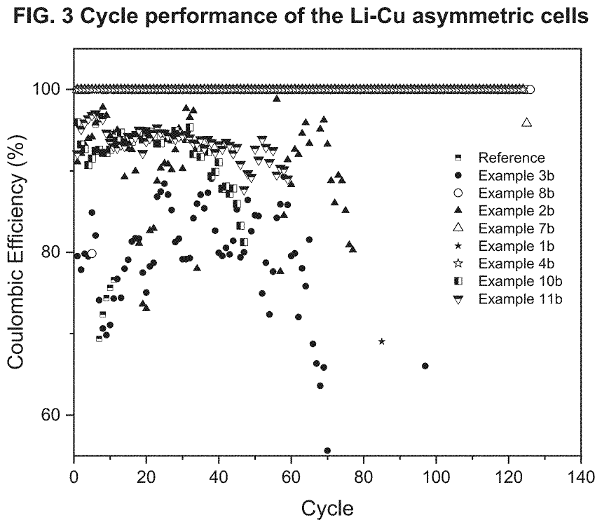

In all cases, using alumina-polymer coatings provided an improved coulombic efficiency of the electrodes when compared with the uncoated electrode material (reference). With the increased alumina particles to polymer weight ratio, as well as using the smaller size of alumina particles, particularly, with fumed alumina of example 4b, the coulombic efficiency of Li—Cu asymmetric cells was improved significantly (FIG. 3, Table 4).

TABLE 4
Coulombic efficiency and volume expansion of Li—Cu
asymmetric cells in the liquid electrolyte.

| | Coulombic | Volume |
|---|---|---|
| Electrode | efficiency, [%] | expansion, [%] |
| Reference without protective | 75.60% | 100% |
| layer | | |
| Example 1b | 95.80% | |
| Example 2b | 89.20% | |
| Example 3b | 87.60% | |
| Example 4b | 99.90% | 10% |
| Example 7b | 99.00% | 30% |
| Example 8b | 90.90% | 50% |
| Example 10b | 92.10% | |
| Example 11b | 93.30% | |

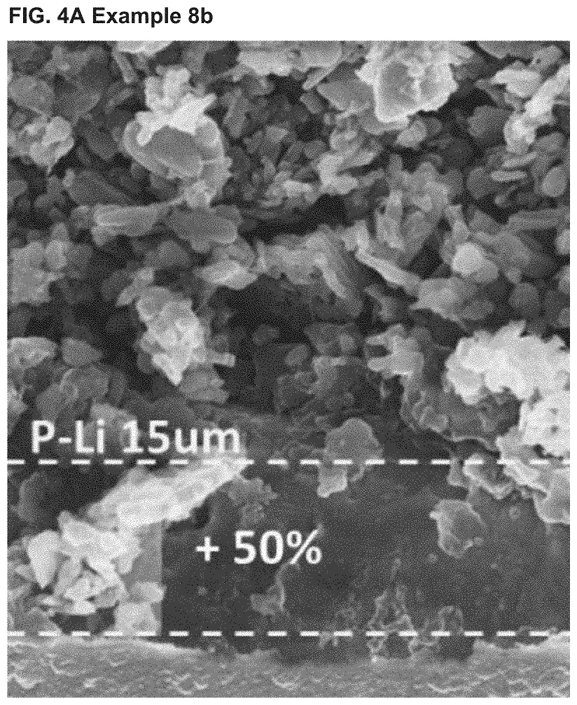

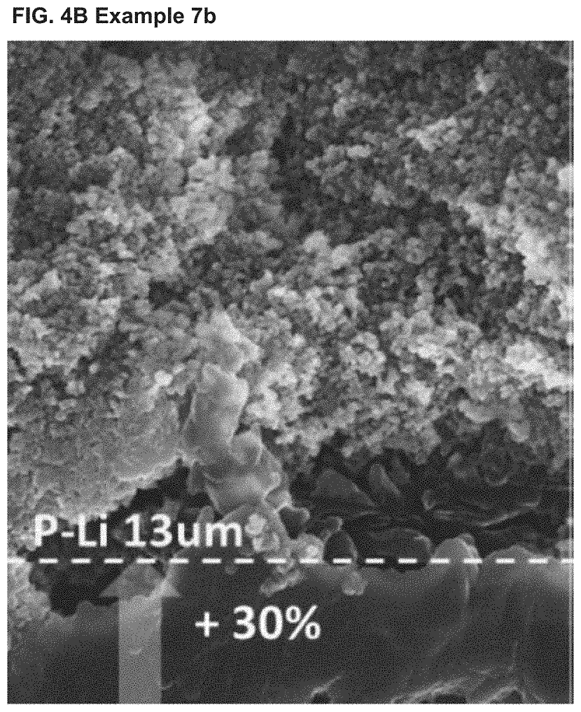

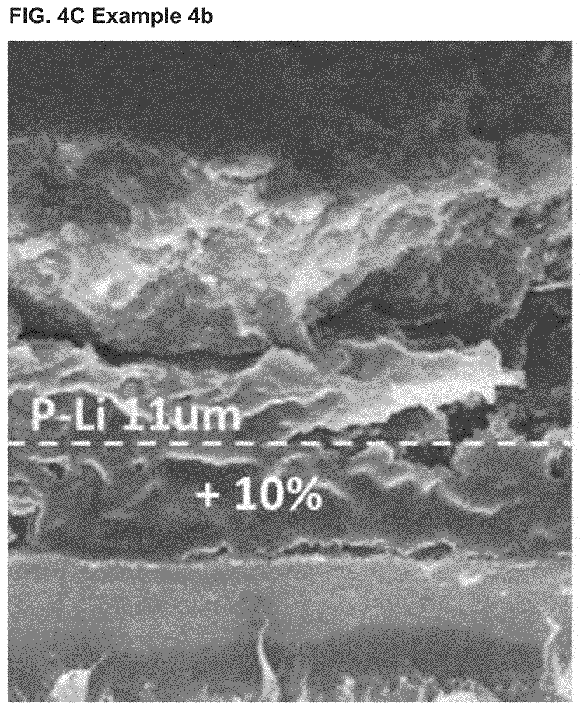

The measurement of the volume expansion ratio was done by SEM analyses. The thickness changes before (10 μm) and after 10 cycles were measured at the current density of 0.5 mA/cm² and the capacity of 2 mAh/cm² and analysed in SEM images for the cells in comparison to the reference without alumina-polymer coating (reference value 100%). Volume expansion ratios of the electrodes from examples 8b, 7b and 4b are shown in FIGS. 4 (A), 4 (B) and 4 (C), respectively.

The Procedure for Li Expansion Test on Cu Foil was as Follows:

a. Discharge 0.5 mA/cm² for 4 h, record every 1 min;

b. Charge 0.5 mA/cm² until >1V, record every 1 min;

c. Discharge 0.5 mA/cm² for 4 h, record every 1 min.

For the electrode of example 4b, this value was minimized down to 10%, whereas the electrodes from examples 7b and 8b with higher alumina:polymer weight ratio but other than in example 4b alumina types, provided volume expansion ratios of 30% and 50%, respectively (Table 4).

1: An electrode for a lithium battery, comprising a metal layer coated with a coating layer comprising
an organic binder, and
a metal compound selected from the group consisting of aluminium oxide, silicon dioxide, zirconium oxide, a mixed oxide comprising zirconium, a mixed oxide comprising aluminium, lithium zirconium phosphate, and a mixture thereof,
wherein the metal compound consists of aggregates of primary particles with a number mean primary particle size d₅₀ of 5 nm-100 nm obtained by a pyrogenic process, and
wherein a weight ratio of the metal compound to the organic binder in the coating layer is from 0.1 to 10.

2: The electrode according to claim 1, wherein the metal compound comprises the mixed oxide comprising zirconium, and wherein the mixed oxide comprising zirconium further comprises one or several elements selected from the group consisting of Li, Na, K, Be, Mg, Ca, Sr, Ba, Zn, Co, Ni, Cu, Mn, B, Al, Ga, In, Fe, Sc, Y, La, Ti, Zr, Hf, Ce, Si, Ge, Sn, Pb, V, Nb, Ta, Mo, and W.

3: The electrode according to claim 1, wherein the metal compound comprises the mixed oxide comprising zirconium, and wherein the mixed oxide comprising zirconium is a compound of a general formula LiₐZr_{b}M_{c}O_{0.5a+2b+d} (I),
wherein
1.5≤a≤15,
0.5≤b≤3.0,
0≤c≤5,
d=0.5c for M=Na, K;
d=c for M=Be, Mg, Ca, Sr, Ba, Zn, Co, Ni, Cu, Mn;
d=1.5c for M=B, Al, Ga, In, Fe, Sc, Y, La;
d=2c for M=Ti, Zr, Hf, Ce, Si, Ge, Sn, Pb;
d=2.5c for M=V, Nb, Ta; and
d=3c for M=Mo, W.

4: The electrode according to claim 1, wherein the coating layer further comprises a lithium salt selected from the group consisting of lithium hexafluorophosphate (LiPF₆), lithium bis 2-(trifluoromethylsulfonyl)imide (LiTFSI), lithium bis (fluorosulfonyl) imide (LiFSI), lithium perchlorate (LiClO₄), lithium tetrafluoroborate (LiBF₄), Li₂SiF₆, lithium triflate, Lithium bis(perfluoroethylsulfonyl)imide (LiN(SO₂CF₂CF₃)₂), lithium nitrate, lithium bis(oxalate)borate, lithium-cyclo-difluoromethane-1,1-bis(sulfonyl)imide, lithium-cyclo-hexafluoropropane-1,1-bis(sulfonyl)imide, and a mixture thereof.

5: The electrode according to claim 1, wherein the metal compound is surface treated with a surface treatment agent selected from the group consisting of an organosilane, a silazane, an acyclic polysiloxane, a cyclic polysiloxane, and a mixture thereof.

6: The electrode according to claim 1, wherein the metal compound has a number mean aggregate particle size d₅₀ of 20 nm-1 μm.

7: The electrode according to claim 1, wherein the weight ratio of the metal compound to the organic binder in the coating layer is from 1 to 6.

8: The electrode according to claim 1, wherein the organic binder is selected from the group consisting of poly(vinylidene fluoride), copolymer of vinylidene fluoride and hexafluoropropylene, poly(vinyl acetate), poly(ethylene oxide), poly(methyl methacrylate), poly(ethyl acrylate), poly(vinyl chloride), poly(urethane), poly(acrylonitrile), copolymer of ethylene and vinyl acetate, carboxyl methyl cellulose, poly(imide), poly(dimethylsiloxane), poly(ethylene oxide), and a mixture thereof.

9: The electrode according to claim 1, wherein the metal layer comprises at least one material selected from the group consisting of lithium, aluminium, copper, silver, gold, nickel, iron, steel, stainless steel, titanium, or a metal alloy thereof.

10: The electrode according to claim 1, wherein a thickness of the metal layer is 0.5 μm-500 μm.

11: The electrode according to claim 1, wherein a thickness of the coating layer is 0.5 μm-100 μm.

12: A process for producing the electrode as defined in claim 1, comprising:
(1) preparing a mixture comprising:
the organic binder,
the metal compound selected from the group consisting of aluminium oxide, silicon dioxide, zirconium oxide, a mixed oxide comprising zirconium, a mixed oxide comprising aluminium, lithium zirconium phosphate, and a mixture thereof, wherein the metal compound consists of aggregates of primary particles with a number mean primary particle size d₅₀ of 5 nm-100 nm and is obtained by a pyrogenic process, and
optionally, a solvent,
wherein the weight ratio of the metal compound to the organic binder is from 0.1 to 10:
(2) coating the mixture prepared in (1) on a surface of the metal layer, to obtain the coating laver; and
(3) optionally, drying and/or curing the coating layer prepared in (2).

13: The process according to claim 12, wherein the solvent used in (1) is selected from the group consisting of 1,2-dimethoxyethane, diethyl ether, tetrahydrofuran, dioxane, bis (2-methoxyethyl) ether, pentane, hexane, heptane, octane, decane, toluene, ethanol, isopropanol, N-Methyl-2-pyrrolidone, triethyl phosphate, dimethyl sulfoxide, methyl ethyl ketone, methyl isobutyl ketone, benzaldehyde, N,N-dimethylformamide, dimethylacetamide, acetonitrile, cyclohexanone, ethyl acetate, propylene carbonate, ethylene carbonate, diethylene glycol monomethyl ether, triethylene glycol methyl ether, acetylacetone, acetone, and a mixture thereof.

14: A method of constructing a battery, comprising:
providing the electrode according to claim 1 as a constituent in a lithium metal or lithium ion battery.

15: A battery comprising the electrode according to claim 1.
